(19) United States
(12) Patent Application Publication
(10) Pub. No.: US 2022/0411578 A1
(43) Pub. Date: Dec. 29, 2022

(54) PROCESS FOR PRODUCING POLYETHER CARBONATE POLYOLS

(71) Applicant: Covestro Intellectual Property GmbH & Co. KG, Leverkusen (DE)

(72) Inventors: Stefanie Braun, Köln (DE); Joerg Hofmann, Krefeld (DE); Michael Traving, Burscheid (DE)

(21) Appl. No.: 17/770,903

(22) PCT Filed: Nov. 30, 2020
(86) PCT No.: PCT/EP2020/083919

§ 371 Date: Apr. 21, 2022

(30) Foreign Application Priority Data
Dec. 4, 2019 (EP) 19213511.9

(51) Int. Cl. C08G 64/34; C08G 64/02

(52) U.S. Cl. CPC C08G 64/34; C08G 64/0208

(57) ABSTRACT

A process for continuous production of polyether carbonate polyols by the addition of alkylene oxide and carbon dioxide in the presence of a DMC catalyst or a metal complex catalyst based on the metals cobalt and/or zinc, onto an H-functional starter substance is provided. Wherein (γ) the H-functional starter substance, alkylene oxide and catalyst are continuously metered into the reaction during the addition and the resulting reaction mixture is continuously discharged from the reactor, wherein (i) before step (γ), a suspension of catalyst in suspension medium and/or H-functional starter substance in the reactor is adjusted to a temperature T₁ ranging from 100° C. to 150° C., wherein T₁ is at least 10% above a temperature T₂ and T₂ is a temperature ranging from 50° C. to 135° C., and (ii) from commencement of the addition of alkylene oxide in step (γ) the temperature is continuously reduced to the temperature T₂.

### CROSS REFERENCE TO RELATED APPLICATIONS

This application is a U.S. national stage application, filed under 35 U.S.C. § 371, of International Application No. PCT/EP2020/083919, which was filed on Nov. 30, 2020, which claims priority to European Patent Application No. 19213511.9, which was filed on Dec. 4, 2019. The contents of each are hereby incorporated by reference into this specification.

### FIELD

The present invention relates to a process for continuously preparing polyethercarbonate polyols by addition of alkylene oxide and carbon dioxide in the presence of a DMC catalyst or a metal complex catalyst based on the metals cobalt and/or zinc onto H-functional starter substance.

### BACKGROUND

The preparation of polyethercarbonate polyols by catalytic reaction of alkylene oxides (epoxides) and carbon dioxide in the presence of H-functional starter substances (“starters”) has been the subject of intensive study for more than 40 years (e.g. Inoue et al, Copolymerization of Carbon Dioxide and Epoxide with Organometallic Compounds; Die Makromolekulare Chemie [Macromolecular Chemistry] 130, 210-220, 1969). This reaction is shown in schematic form in scheme (I), where R is an organic radical such as alkyl, alkylaryl or aryl, each of which may also contain heteroatoms, for example O, S, Si, etc., and where e, f and g are integers, and where the product shown here in scheme (I) for the polyethercarbonate polyol should merely be understood in such a way that blocks having the structure shown may in principle be present in the polyethercarbonate polyol obtained, but the sequence, number and length of the blocks and the OH functionality of the starter may vary and is not restricted to the polyethercarbonate polyol shown in scheme (I). This reaction (see scheme (I)) is highly advantageous from an environmental standpoint since this reaction is the conversion of a greenhouse gas such as CO₂ to a polymer. A further product formed, actually a by-product, is the cyclic carbonate shown in scheme (I) (for example, when R═CH₃, propylene carbonate).

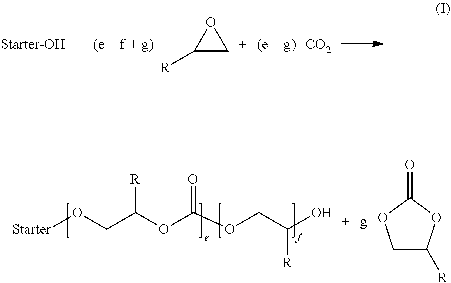

EP-A 0 222 453 discloses a process for preparing polycarbonates from alkylene oxides and carbon dioxide using a catalyst system composed of DMC catalyst and a cocatalyst such as zinc sulfate. This polymerization is initiated here by one-off contacting of a portion of the alkylene oxide with the catalyst system. Only thereafter are the remaining amount of alkylene oxide and the carbon dioxide metered in simultaneously. The amount of 60% by weight of alkylene oxide compound relative to the H-functional starter substance, as specified in EP-A 0 222 453 for the activation step in examples 1 to 7, is high and has the disadvantage that this constitutes a certain safety risk for industrial scale applications because of the high exothermicity of the homopolymerization of alkylene oxide compounds.

EP 3 164 442 B1 discloses a process for preparing polyethercarbonate polyols, characterized in that the reactor is initially charged with one or more H-functional starter substances, and in that one or more H-functional starter substances are metered continuously into the reactor during the reaction. EP 3 164 442 discloses that, in the case of a free alkylene oxide concentration of 5.0% by weight, a stable process regime was no longer possible on account of significant fluctuations in pressure and temperature.

### SUMMARY

It was therefore an object of the present invention to provide a process for continuously preparing polyethercarbonate polyols on the production scale, wherein a more stable process regime is possible.

It has been found that, surprisingly, the technical object is achieved by a process for continuously preparing polyethercarbonate polyols by addition of alkylene oxide and carbon dioxide in the presence of a DMC catalyst or a metal complex catalyst based on the metals cobalt and/or zinc onto H-functional starter substance, wherein
(α) a portion of the H-functional starter substance and/or a suspension medium having no H-functional groups is optionally initially charged in a reactor optionally together with DMC catalyst or a metal complex catalyst based on the metals and zinc and/or cobalt,
(β) a DMC catalyst is optionally activated by adding a portion (based on the total amount of alkylene oxide used in the activation and copolymerization) of the alkylene oxide to the mixture resulting from step (α), wherein this addition of a portion of alkylene oxide can optionally be carried out in the presence of CO₂ and wherein the temperature spike (“hotspot”) occurring on account of the subsequent exothermic chemical reaction and/or a pressure drop in the reactor is awaited in each case and wherein step (β) for activation may also be carried out two or more times.
(γ) H-functional starter substance, alkylene oxide and catalyst are metered continuously into the reactor during the addition, and the resulting reaction mixture is removed continuously from the reactor,
   characterized in that
(i) before step (γ) and after optional steps (α) and/or (β), a suspension of catalyst in suspension medium and/or H-functional starter substance in the reactor is adjusted to a temperature T₁ in the range from 100 to 150° C., where T₁ is at least 10%, based on T₂, above a temperature T₂ and T₂ is a temperature in the range from 50 to 135° C.,
(ii) from commencement of the addition of alkylene oxide in step (γ), the temperature T₁ established in (i) in the reactor is reduced continuously down to the temperature T₂, and the temperature T₂ is attained no earlier than after 50 minutes.

### DETAILED DESCRIPTION

Step (α):

In the process, a portion of the H-functional starter substance and/or a suspension medium having no H-functional groups can first be initially charged in the reactor. Subsequently, any amount of catalyst required for the polyaddition is added to the reactor. The sequence of addition is not critical. It is also possible for first the catalyst and then a portion of the H-functional starter substance to be added to the reactor. It is alternatively also possible first to suspend the catalyst in a portion of H-functional starter substance and then to charge the reactor with the suspension.

In a preferred embodiment of the invention, in step (α) the reactor is initially charged with an H-functional starter substance, optionally together with catalyst, without including any suspension medium not containing H-functional groups in the reactor charge.

The catalyst is preferably used in an amount such that the content of catalyst in the resulting reaction product is 10 to 10 000 ppm, more preferably 20 to 5000 ppm, and most preferably 50 to 500 ppm. In a preferred embodiment, inert gas (for example argon or nitrogen), an inert gas/carbon dioxide mixture or carbon dioxide is introduced into the resulting mixture of (α) a portion of H-functional starter substance and (b) catalyst at a temperature of 90° C. to 150° C., more preferably of 100° C. to 140° C., and at the same time a reduced pressure (absolute) of 10 mbar to 800 mbar, more preferably of 50 mbar to 200 mbar, is applied.

In an alternative preferred embodiment, the resulting mixture of (α) a portion of H-functional starter substance and (b) catalyst is contacted at a temperature of 90° C. to 150° C., more preferably of 100° C. to 140° C., at least once, preferably three times, with 1.5 bar to 10 bar (absolute), more preferably 3 bar to 6 bar (absolute), of an inert gas (for example argon or nitrogen), an inert gas/carbon dioxide mixture or carbon dioxide and then the gauge pressure is in each case reduced to about 1 bar (absolute).

The catalyst can be added in solid form or as a suspension in suspension medium containing no H-functional groups, in H-functional starter substance or in a mixture thereof.

In a further preferred embodiment, in step (α),
(α-I) a portion of the H-functional starter substances and/or suspension medium is initially charged and
(α-II) the temperature of the portion of H-functional starter substance is brought to 50 to 200° C., preferably 80 to 160° C., more preferably 100 to 140° C., and/or the pressure in the reactor is lowered to less than 500 mbar, preferably 5 mbar to 100 mbar, in the course of which an inert gas stream (for example of argon or nitrogen), an inert gas/carbon dioxide stream or a carbon dioxide stream is optionally passed through the reactor,

wherein the catalyst is added to the portion of H-functional starter substance in step (α-I) or immediately thereafter in step (α-II).

The portion of the H-functional starter substance used in (α) may contain component K, preferably in an amount of at least 50 ppm, more preferably of 100 to 10 000 ppm.

Step (β):

Step (β) serves to activate the DMC catalyst. This step may optionally be performed under an inert gas atmosphere, under an atmosphere composed of an inert gas/carbon dioxide mixture or under a carbon dioxide atmosphere. Activation in the context of this invention refers to a step wherein a portion of alkylene oxide is added to the DMC catalyst suspension at temperatures of 90° C. to 150° C. and the addition of the alkylene oxide is then interrupted, a subsequent exothermic chemical reaction causing an evolution of heat to be observed which can lead to a temperature spike (“hotspot”) and the conversion of alkylene oxide and optionally CO₂ causing a pressure drop to be observed in the reactor. The process step of activation is the period of time from the addition of the portion of alkylene oxide, optionally in the presence of CO₂, to the DMC catalyst until the occurrence of the evolution of heat. Optionally, the portion of the alkylene oxide can be added to the DMC catalyst in a plurality of individual steps, optionally in the presence of CO₂, and then the addition of the alkylene oxide can be stopped in each case. In this case, the process step of activation comprises the period from the addition of the first portion of alkylene oxide, optionally in the presence of CO₂, to the DMC catalyst until the occurrence of the evolution of heat after addition of the last portion of alkylene oxide. In general, the activation step may be preceded by a step for drying the DMC catalyst and optionally the H-functional starter substance at elevated temperature and/or reduced pressure, optionally with passage of an inert gas through the reaction mixture.

The alkylene oxide (and optionally the carbon dioxide) can in principle be metered in in different ways. The metered addition can be commenced from the vacuum or at a previously chosen supply pressure. The supply pressure is preferably established by introduction of an inert gas (for example nitrogen or argon) or of carbon dioxide, where the pressure (in absolute terms) is 5 mbar to 100 bar, preferably 10 mbar to 50 bar and more preferably 20 mbar to 50 bar.

In a preferred embodiment, the amount of the alkylene oxide used in the activation in step (β) is 0.1% to 25.0% by weight, preferably 1.0% to 20.0% by weight, more preferably 2.0% to 16.0% by weight (based on the amount of H-functional starter substance used in step (α)). The alkylene oxide can be added in one step or in two or more portions. Preferably, addition of a portion of the alkylene oxide is followed by interruption of the addition of the alkylene oxide until the occurrence of evolution of heat, and only then is the next portion of alkylene oxide added. A two-stage activation is also preferred (step β), wherein
(β1) in a first activation stage a first portion of alkylene oxide is added under inert gas atmosphere or carbon dioxide atmosphere and
(β2) in a second activation stage a second portion of alkylene oxide is added under carbon dioxide atmosphere.

Step (γ):

According to the invention, the metered addition of H-functional starter substance, alkylene oxide and optionally also the carbon dioxide into the reactor is continuous. The term “continuous” as used here can be defined as a mode of addition of a reactant such that a concentration of the reactant effective for the copolymerization is maintained, meaning that, for example, the metered addition can be effected with a constant metering rate, with a varying metering rate or in portions. Optionally, the H-functional starter substance used in step (γ) contains at least 50 ppm of component K, preferably at least 100 ppm. In an alternative embodiment, the H-functional starter substance used in step (γ) contains at least 1000 ppm of component K.

It is possible, during the addition of the alkylene oxide and/or of the H-functional starter substance, to increase or lower the CO₂ pressure gradually or stepwise or to leave it constant. The total pressure is preferably kept constant during the reaction by metered addition of further carbon dioxide. The metered addition of the alkylene oxide and/or H-functional starter substance is effected simultaneously or sequentially with respect to the metered addition of carbon dioxide. It is possible to meter in the alkylene oxide at a constant metering rate or to increase or lower the metering rate gradually or in steps or to add the alkylene oxide in portions. The alkylene oxide is preferably added to the reaction mixture at a constant addition rate. If two or more alkylene oxides and/or H-functional starter substances are used for synthesis of the polyethercarbonate polyols, the alkylene oxides and/or H-functional starter substances can be metered in individually or as a mixture. The metered addition of the alkylene oxides and/or of the H-functional starter substances can be effected simultaneously or sequentially, each via separate metering points (addition points), or via one or more metering points, in which case the alkylene oxides and/or the H-functional starter substances can be metered in individually or as a mixture.

Preferably, an excess of carbon dioxide is used, based on the calculated amount of carbon dioxide incorporated in the polyethercarbonate polyol, since an excess of carbon dioxide is advantageous because of the low reactivity of carbon dioxide. The amount of carbon dioxide may be determined via the total pressure under the particular reaction conditions. An advantageous total pressure (absolute) for the copolymerization for preparing the polyethercarbonate polyols has been found to be in the range from 0.01 to 120 bar, preferably 0.1 to 110 bar, more preferably from 1 to 100 bar. It is possible to feed in the carbon dioxide continuously or in portions. The amount of the carbon dioxide (reported as pressure) may vary in the course of addition of the alkylene oxide. CO₂ can also be added to the reactor in solid form and then be converted to the gaseous, dissolved, liquid and/or supercritical state under the chosen reaction conditions.

A preferred embodiment of the process according to the invention is inter alia characterized in that in step (γ) the total amount of H-functional starter substance is added. This addition can be effected at a constant metering rate, with a varying metering rate, or in portions.

For the process of the invention, it has additionally been found that the copolymerization (step (γ)) for preparation of the polyethercarbonate polyols is conducted preferably at 60° C. to 130° C., more preferably at 70° C. to 125° C. and most preferably at 90° C. to 120° C. If temperatures are set below 50° C., the reaction generally becomes very slow. At temperatures above 150° C., the amount of unwanted by-products rises significantly.

The metered addition of the alkylene oxide, H-functional starter substance and the catalyst may be effected via separate or common feed points. In a preferred embodiment, alkylene oxide and H-functional starter substance are continuously supplied to the reaction mixture via separate feed points. This addition of H-functional starter substance can be effected as a continuous metered addition to the reactor or in portions.

Steps (α), (β) and (γ) may be performed in the same reactor or may each be performed separately in different reactors. Particularly preferred reactor types are: tubular reactors, stirred tanks and loop reactors.

Polyethercarbonate polyols can be prepared in a stirred tank, in which case the stirred tank, according to the design and mode of operation, is cooled via the reactor jacket, internal cooling surfaces and/or cooling surfaces within a pumped circulation system. In the continuous reaction regime of the invention, in which the resulting reaction mixture is withdrawn continuously from the reactor, particular attention should be paid to the rate of metered addition of the alkylene oxide. This should be set such that, in spite of the inhibiting action of the carbon dioxide, the alkylene oxides are depleted by reaction sufficiently quickly.

The concentration of free alkylene oxides in the reaction mixture during the activation step (step β) is preferably >0% to 100% by weight, more preferably >0% to 50% by weight, most preferably >0% to 20% by weight (in each case based on the weight of the reaction mixture).

The free alkylene oxide concentration in the reaction mixture during the addition (step γ), is preferably 1.5% to 5.0% by weight, more preferably 1.5% to 4.5% by weight, especially preferably 2.0% to 4.0% by weight (based in each case on the weight of the reaction mixture).

According to the invention, the polyethercarbonate polyols are prepared in a continuous process comprising both a continuous copolymerization and a continuous addition of H-functional starter substance.

The invention preferably also provides a process wherein, in step (γ), H-functional starter substance containing at least 50 ppm of component K, alkylene oxide and catalyst are metered continuously into the reactor in the presence of carbon dioxide (“copolymerization”), and wherein the resulting reaction mixture (comprising the reaction product) is removed continuously from the reactor. Preferably, in step (γ), the catalyst is added continuously in suspension in H-functional starter substance.

For example, for the continuous process for preparing the polyethercarbonate polyols in steps (α) and (β), a mixture containing activated DMC catalyst is prepared, then, in step (γ),
(γ1) one portion each of one or more H-functional starter substances, one or more alkylene oxides and carbon dioxide are metered in to initiate the copolymerization, and
(γ2) during the progress of the copolymerization, the remaining amount of each of DMC catalyst, one or more starter substances and alkylene oxides is metered in continuously in the presence of carbon dioxide, with simultaneous continuous removal of resulting reaction mixture from the reactor.

In step (γ), the catalyst is preferably added in the form of a suspension in the H-functional starter substance, the amount preferably being chosen such that the content of catalyst in the resulting reaction product is 10 to 10 000 ppm, more preferably 20 to 5000 ppm, and most preferably 50 to 500 ppm.

It is preferable when steps (α) and/or (β) are performed in a first reactor, and the resulting reaction mixture is then transferred into a second reactor for the copolymerization of step (γ). However, it is also possible to perform steps (α), (β) and (γ) in one reactor.

It has also been found that the process of the present invention can be used for preparation of large amounts of the polyethercarbonate polyol product, in which case a DMC catalyst activated according to steps (α) and (β) in a portion of the H-functional starter substances and/or in suspension medium is initially used, and the DMC catalyst is added without prior activation during the copolymerization (γ).

The term “continuously” used here can be defined as the mode of addition of a relevant catalyst or reactant such that an essentially continuous effective concentration of the catalyst or the reactant is maintained. The catalyst supply and the supply of the reactants may be effected in a truly continuous manner or in relatively tightly spaced increments. Equally, continuous starter addition may be effected in a truly continuous manner or in increments. There would be no departure from the present process in adding a catalyst or reactants incrementally such that the concentration of the materials added drops essentially to zero for a period of time before the next incremental addition. However, it is preferable for the catalyst concentration to be kept substantially at the same concentration during the main portion of the course of the continuous reaction, and for starter substance to be present during the main portion of the copolymerization process. An incremental addition of catalyst and/or reactant which does not substantially influence the nature of the product is nevertheless “continuous” in that sense in which the term is being used here. It is possible, for example, to provide a recycling loop in which a portion of the reacting mixture is recycled to a prior point in the process, thus smoothing out discontinuities caused by incremental additions.

According to the invention,
(i) before step (γ) and after optional steps (α) and/or (β), a suspension of catalyst in suspension medium and/or H-functional starter substance in the reactor is adjusted to a temperature T₁ in the range from 100 to 150° C., where T₁ is at least 10%, based on T₂, above a temperature T₂ and T₂ is a temperature in the range from 50 to 135° C.,
(ii) from commencement of the addition of alkylene oxide in step (γ), the temperature T₁ established in (i) in the reactor is reduced continuously down to the temperature T₂, and the temperature T₂ is attained no earlier than after 50 minutes.

The temperature T₁ is set within the range from 100 to 150° C., preferably from 110 to 150° C., more preferably from 120 to 140° C., and is at least 10%, preferably at least 15%, more preferably at least 20%, based in each case on T₂, above the temperature T₂. The temperature T₂ is the temperature of the continuous process in the steady state, i.e. with constant mass flow rates of the reactants and constant fill level of the reactor. From commencement of the addition of the alkylene oxide, the temperature T₁ is reduced continuously until the temperature T₂ is attained. The temperature T₂ is within the range from 50 to 135° C., preferably from 60 to 130° C., more preferably from 70 to 125° C., especially preferably from 90 to 120° C. The reduction in temperature may be linear or in multiple stages, in such a way that the temperature T₂ is attained no earlier than after 50 minutes, preferably 100 minutes, more preferably 120 minutes.

The process of the invention can be used in the first startup of a process for continuously preparing polyethercarbonate polyols, and when restarting such a process. What is meant by restarting in the context of this invention is that a continuous process for preparing polyethercarbonate polyols has been stopped and started up again without removing the entire reaction mixture. The restart is preferably effected after a shutdown of 24 hours or less, more preferably after a shutdown of 12 hours or less, especially preferably after a shutdown of 4 hours or less, after the continuous process for preparing polyethercarbonate polyols has been stopped.

Alkylene Oxide

In general, it is possible to use alkylene oxides (epoxides) having 2-24 carbon atoms for the process. The alkylene oxides having 2-24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C₁-C₂₄ esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. The alkylene oxide used is preferably ethylene oxide and/or propylene oxide, especially propylene oxide. In the process of the invention, the alkylene oxide used may also be a mixture of alkylene oxides.

H-Functional Starter Substance

Suitable H-functional starter substances (“starters”) used may be compounds having alkoxylation-active hydrogen atoms and having a molar mass of 18 to 4500 g/mol, preferably of 62 to 500 g/mol and more preferably of 62 to 182 g/mol.

In the context of this invention, the number-average molar mass Mₙ (also: molecular weight) is determined by gel permeation chromatography to DIN 55672-1 (August 2007).

Alkoxylation-active groups having active H atoms are, for example, —OH, —NH₂ (primary amines), —NH— (secondary amines), —SH, and —CO₂H, preferably —OH and —NH₂, more preferably —OH. H-functional starter substances used are, for example, one or more compounds selected from the group consisting of mono- or polyhydric alcohols, polyfunctional amines, polyfunctional thiols, amino alcohols, thio alcohols, hydroxy esters, polyether polyols, polyester polyols, polyester ether polyols, polyethercarbonate polyols, polycarbonate polyols, polycarbonates, polyethyleneimines, polyetheramines, polytetrahydrofurans (e.g. PolyTHF® from BASF), polytetrahydrofuran amines, polyether thiols, polyacrylate polyols, castor oil, the mono- or diglyceride of ricinoleic acid, monoglycerides of fatty acids, chemically modified mono-, di- and/or triglycerides of fatty acids, and C₁-C₂₄ alkyl fatty acid esters containing an average of at least 2 OH groups per molecule. The C₁-C₂₄ alkyl fatty acid esters containing an average of at least 2 OH groups per molecule are for example commercial products such as Lupranol Balance® (from BASF AG), Merginol® products (from Hobum Oleochemicals GmbH), Sovermol® products (from Cognis Deutschland GmbH & Co. KG) and Soyol®TM products (from USSC Co.).

Monofunctional starter substances used may be alcohols, amines, thiols and carboxylic acids. Monofunctional alcohols that may be used include: methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Useful monofunctional amines include: butylamine, tert-butylamine, pentylamine, hexylamine, aniline, aziridine, pyrrolidine, piperidine, morpholine. Employable monofunctional thiols include: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Polyhydric alcohols suitable as H-functional starter substances are, for example, dihydric alcohols (for example ethylene glycol, diethylene glycol, propylene glycol, dipropylene glycol, propane-1,3-diol, butane-1,4-diol, butene-1,4-diol, butyne-1,4-diol, neopentyl glycol, pentane-1,5-diol, methylpentanediols (for example 3-methylpentane-1,5-diol), hexane-1,6-diol; octane-1,8-diol, decane-1,10-diol, dodecane-1,12-diol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, in particular castor oil), and all modification products of these aforementioned alcohols with different amounts of ε-caprolactone.

The H-functional starter substance may also be selected from the substance class of the polyether polyols having a molecular weight Mₙ in the range from 18 to 4500 g/mol and a functionality of 2 to 3. Preference is given to polyether polyols formed from repeating ethylene oxide and propylene oxide units, preferably having a proportion of propylene oxide units of 35% to 100%, more preferably having a proportion of propylene oxide units of 50% to 100%. These may be random copolymers, gradient copolymers, alternating copolymers or block copolymers of ethylene oxide and propylene oxide.

The H-functional starter substance may also be selected from the substance class of the polyester polyols. The polyester polyols used are at least difunctional polyesters. Polyester polyols preferably consist of alternating acid and alcohol units. Acid components used are, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Alcohol components used are, for example, ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. If the alcohol components used are dihydric or polyhydric polyether polyols, the result is polyester ether polyols which can likewise serve as starter substances for preparation of the polyethercarbonate polyols.

In addition, H-functional starter substances used may be polycarbonatediols which are prepared, for example, by reaction of phosgene, dimethyl carbonate, diethyl carbonate or diphenyl carbonate and difunctional alcohols or polyester polyols or polyether polyols. Examples of polycarbonates may be found, for example, in EP-A 1359177.

In a further embodiment of the invention, it is possible to use polyethercarbonate polyols as H-functional starter substances. More particularly, polyethercarbonate polyols obtainable by the process of the invention described here are used. To this end, these polyethercarbonate polyols used as H-functional starter substances are prepared beforehand in a separate reaction step.

The H-functional starter substance generally has a functionality (i.e. the number of polymerization-active H atoms per molecule) of 1 to 8, preferably of 2 or 3. The H-functional starter substance is used either individually or as a mixture of at least two H-functional starter substances.

It it is particularly preferable when the H-functional starter substance is at least one of compounds selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol, sorbitol, polyethercarbonate polyols having a molecular weight Mₙ in the range from 150 to 8000 g/mol with a functionality of 2 to 3, and polyether polyols having a molecular weight Mₙ in the range from 150 to 8000 g/mol with a functionality of 2 to 3.

In a particularly preferred embodiment, in step (α) the portion of H-functional starter substance is selected from at least one compound of the group consisting of polyethercarbonate polyols having a molecular weight Mₙ in the range from 150 to 8000 g/mol with a functionality of 2 to 3, and polyether polyols having a molecular weight Mₙ in the range from 150 to 8000 g/mol and a functionality of 2 to 3. In a further particularly preferred embodiment, the H-functional starter substance in step (γ) is selected from at least one compound of the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol and sorbitol.

The polyethercarbonate polyols are prepared by catalytic addition of carbon dioxide and alkylene oxide onto an H-functional starter substance. In the context of the invention, “H-functional” is understood to mean the number of alkoxylation-active hydrogen atoms per molecule of the starter substance.

The H-functional starter substance which is metered continuously into the reactor during the reaction may contain component K.

Component K

Compounds suitable as component K are characterized in that they contain at least one phosphorus-oxygen bond. Examples of suitable components K are phosphoric acid and phosphoric salts, phosphoryl halides, phosphoramides, phosphoric esters and salts of the mono- and diesters of phosphoric acid.

In the context of the invention, the esters cited as possible components K above and hereinafter are understood in each case to mean the alkyl ester, aryl ester and/or alkaryl ester derivatives.

Examples of suitable phosphoric esters include mono-, di- or triesters of phosphoric acid, mono-, di-, tri- or tetraesters of pyrophosphoric acid and mono-, di-, tri-, tetra- or polyesters of polyphosphoric acid with alcohols having 1 to 30 carbon atoms. Examples of compounds suitable as component K include: triethyl phosphate, diethyl phosphate, monoethyl phosphate, tripropyl phosphate, dipropyl phosphate, monopropyl phosphate, tributyl phosphate, dibutyl phosphate, monobutyl phosphate, trioctyl phosphate, tris(2-ethylhexyl) phosphate, tris(2-butoxyethyl) phosphate, diphenyl phosphate, dicresyl phosphate, fructose 1,6-biphosphate, glucose 1-phosphate, bis(dimethylamido)phosphoric chloride, bis(4-nitrophenyl) phosphate, cyclopropylmethyl diethyl phosphate, dibenzyl phosphate, diethyl 3-butenyl phosphate, dihexadecyl phosphate, diisopropyl chlorophosphate, diphenyl phosphate, diphenyl chlorophosphate, 2-hydroxyethyl methacrylate phosphate, mono(4-chlorophenyl) dichlorophosphate, mono(4-nitrophenyl) dichlorophosphate, monophenyl dichlorophosphate, tridecyl phosphate, tricresyl phosphate, trimethyl phosphate, triphenyl phosphate, phosphoric acid tripyrolidide, phosphorus sulfochloride, dimethylamidophosphoric dichloride, methyl dichlorophosphate, phosphoryl bromide, phosphoryl chloride, phosphoryl quinoline chloride calcium salt and O-phosphorylethanolamine, alkali metal and ammonium dihydrogenphosphates, alkali metal, alkaline earth metal and ammonium hydrogenphosphates, alkali metal, alkaline earth metal and ammonium phosphates.

The term “esters of phosphoric acid” (phosphoric esters) is understood also to include the products obtainable by propoxylation of phosphoric acid (available as Exolit® OP 560 for example).

Other suitable components K are phosphonic acid and phosphorous acid and also mono- and diesters of phosphonic acid and mono-, di- and triesters of phosphorous acid and their respective salts, halides and amides.

Examples of suitable phosphonic esters include mono- or diesters of phosphonic acid, alkylphosphonic acids, arylphosphonic acids, alkoxycarbonylalkylphosphonic acids, alkoxycarbonylphosphonic acids, cyanoalkylphosphonic acids and cyanophosphonic acids or mono-, di-, tri- or tetraesters of alkyldiphosphonic acids with alcohols having 1 to 30 carbon atoms. Examples of suitable phosphorous esters include mono-, di- or triesters of phosphorous acid with alcohols having 1 to 30 carbon atoms. This includes, for example, phenylphosphonic acid, butylphosphonic acid, dodecylphosphonic acid, ethylhexylphosphonic acid, octylphosphonic acid, ethylphosphonic acid, methylphosphonic acid, octadecylphosphonic acid and their mono- and dimethyl esters, ethyl esters, butyl esters, ethylhexyl esters or phenyl esters, dibutyl butylphosphonate, dioctyl phenylphosphonate, triethyl phosphonoformate, trimethyl phosphonoacetate, triethyl phosphonoacetate, trimethyl 2-phosphonopropionate, triethyl 2-phosphonopropionate, tripropyl 2-phosphonopropionate, tributyl 2-phosphonopropionate, triethyl 3-phosphonopropionate, triethyl 2-phosphonobutyrate, triethyl 4-phosphonocrotonate, (12-phosphonododecyl)phosphonic acid, phosphonoacetic acid, methyl P,P-bis(2,2,2-trifluoroethyl)phosphonoacetate, trimethylsilyl P,P-diethylphosphonoacetate, tert-butyl P,P-dimethylphosphonoacetate, P,P-dimethyl phosphonoacetate potassium salt, P,P-dimethylethyl phosphonoacetate, 16-phosphonohexadecanoic acid, 6-phosphonohexanoic acid, N-(phosphonomethyl)glycine, N-(phosphonomethyl)glycine monoisopropylamine salt, N-(phosphonomethyl)iminodiacetic acid, (8-phosphonooctyl)phosphonic acid, 3-phosphonopropionic acid, 11-phosphonoundecanoic acid, pinacol phosphonate, trilauryl phosphite, tris(3-ethyloxethanyl-3-methyl) phosphite, heptakis(dipropylene glycol) phosphite, 2-cyanoethyl bis(diisopropylamido)phosphite, methyl bis(diisopropylamido)phosphite, dibutyl phosphite, dibenzyl (diethylamido)phosphite, di-tert-butyl (diethylamido)phosphite, diethyl phosphite, diallyl (diisopropylamido)phosphite, dibenzyl (diisopropylamido)phosphite, di-tert-butyl (diisopropylamido)phosphite, dimethyl (diisopropylamido)phosphite, dibenzyl (dimethylamido)phosphite, dimethyl phosphite, trimethylsilyl dimethylphosphite, diphenyl phosphite, methyl dichlorophosphite, mono(2-cyanoethyl) diisopropylamidochlorophosphite, o-phenylene chlorophosphite, tributyl phosphite, triethyl phosphite, triisopropyl phosphite, triphenyl phosphite, tris(tert-butyl-dimethylsilyl) phosphite, tris-1,1,1,3,3,3-hexafluoro-2-propyl phosphite, tris(trimethylsilyl) phosphite, dibenzyl phosphite. The term “esters of phosphorous acid” is also understood to include the products obtainable by propoxylation of phosphorous acid (available as Exolit® OP 550 for example).

Other suitable components K are phosphinic acid, phosphonous acid and phosphinous acid and their respective esters. Examples of suitable phosphinic esters include esters of phosphinic acid, alkylphosphinic acids, dialkylphosphinic acids or arylphosphinic acids with alcohols having 1 to 30 carbon atoms. Examples of suitable phosphonous esters include mono- and diesters of phosphonous acid or arylphosphonous acid with alcohols having 1 to 30 carbon atoms. This includes, for example, diphenylphosphinic acid or 9,10-dihydro-9-oxa-10-phosphaphenanthrene 10-oxide.

The esters of phosphoric acid, phosphonic acid, phosphorous acid, phosphinic acid, phosphonous acid or phosphinous acid suitable as component K are generally obtained by reaction of phosphoric acid, pyrophosphoric acid, polyphosphoric acids, phosphonic acid, alkylphosphonic acids, arylphosphonic acids, alkoxycarbonylalkylphosphonic acids, alkoxycarbonylphosphonic acids, cyanoalkylphosphonic acids, cyanophosphonic acid, alkyldiphosphonic acids, phosphonous acid, phosphorous acids, phosphinic acid, phosphinous acid or the halogen derivatives or phosphorus oxides thereof with hydroxy compounds having 1 to 30 carbon atoms such as methanol, ethanol, propanol, butanol, pentanol, hexanol, heptanol, octanol, nonanol, decanol, dodecanol, tridecanol, tetradecanol, pentadecanol, hexadecanol, heptadecanol, octadecanol, nonadecanol, methoxymethanol, ethoxymethanol, propoxymethanol, butoxymethanol, 2-ethoxy ethanol, 2-propoxy ethanol, 2-butoxyethanol, phenol, ethyl hydroxyacetate, propyl hydroxyacetate, ethyl hydroxypropionate, propyl hydroxypropionate, ethane-1,2-diol, propane-1,2-diol, 1,2,3-trihydroxypropane, 1,1,1-trimethylolpropane or pentaerythritol.

Phosphine oxides suitable as component K contain one or more alkyl, aryl or aralkyl groups having 1-30 carbon atoms bonded to the phosphorus. Preferred phosphine oxides have the general formula R₃P═O where R is an alkyl, aryl or aralkyl group having 1-20 carbon atoms. Examples of suitable phosphine oxides include trimethylphosphine oxide, tri(n-butyl)phosphine oxide, tri(n-octyl)phosphine oxide, triphenylphosphine oxide, methyldibenzylphosphine oxide and mixtures thereof.

Also suitable as component K are compounds of phosphorus that can form one or more P—O bond(s) by reaction with OH-functional compounds (such as water or alcohols for example). Examples of such compounds of phosphorus that are useful include phosphorus(V) sulfide, phosphorus tribromide, phosphorus trichloride and phosphorus triiodide. It is also possible to use any desired mixtures of the abovementioned compounds as component K. Phosphoric acid is particularly preferred as component K.

Suspension Medium

Any suspension medium used does not contain any H-functional groups. Suitable suspension media having no H-functional groups are all polar aprotic, weakly polar aprotic and nonpolar aprotic solvents, none of which contain any H-functional groups. Suspension media having no H-functional groups that are used may also be a mixture of two or more of these suspension media. The following polar aprotic solvents are mentioned here by way of example: 4-methyl-2-oxo-1,3-dioxolane (also referred to hereinafter as cyclic propylene carbonate or cPC), 1,3-dioxolan-2-one (also referred to hereinafter as cyclic ethylene carbonate or cEC), acetone, methyl ethyl ketone, acetonitrile, nitromethane, dimethyl sulfoxide, sulfolane, dimethylformamide, dimethylacetamide and N-methylpyrrolidone. The group of the nonpolar aprotic and weakly polar aprotic solvents includes, for example, ethers, for example dioxane, diethyl ether, methyl tert-butyl ether and tetrahydrofuran, esters, for example ethyl acetate and butyl acetate, hydrocarbons, for example pentane, n-hexane, benzene and alkylated benzene derivatives (e.g. toluene, xylene, ethylbenzene) and chlorinated hydrocarbons, for example chloroform, chlorobenzene, dichlorobenzene and carbon tetrachloride. Preferred suspension media used having no H-functional groups are 4-methyl-2-oxo-1,3-dioxolane, 1,3-dioxolan-2-one, toluene, xylene, ethylbenzene, chlorobenzene and dichlorobenzene, and mixtures of two or more of these suspension media; particular preference is given to 4-methyl-2-oxo-1,3-dioxolane and 1,3-dioxolan-2-one or a mixture of 4-methyl-2-oxo-1,3-dioxolane and 1,3-dioxolan-2-one.

It is optionally possible, in step (γ), to meter in 2% by weight to 20% by weight of the suspension medium, based on the sum total of the components metered in in step (γ).

DMC Catalysts

DMC catalysts for use in the homopolymerization of alkylene oxides are known in principle from the prior art (see, for example, U.S. Pat. Nos. 3,404,109, 3,829,505, 3,941,849 and 5,158,922). DMC catalysts, which are described, for example, in U.S. Pat. No. 5,470,813, EP-A 700 949, EP-A 743 093, EP-A 761 708, WO 97/40086, WO 98/16310 and WO 00/47649, have a very high activity and enable the preparation of polyethercarbonate polyols at very low catalyst concentrations, such that there is generally no need to separate the catalyst from the finished product. A typical example is that of the highly active DMC catalysts which are described in EP-A 700 949 and contain not only a double metal cyanide compound (e.g. zinc hexacyanocobaltate(III)) and an organic complex ligand (e.g. tert-butanol) but also a polyether having a number-average molecular weight greater than 500 g/mol.

The DMC catalysts are preferably obtained by
(A) in the first step reacting an aqueous solution of a metal salt with the aqueous solution of a metal cyanide salt in the presence of one or more organic complex ligands, e.g. of an ether or alcohol,
(B) wherein in the second step the solid is separated from the suspension obtained from (A) by means of known techniques (such as centrifugation or filtration),
(C) wherein in a third step the isolated solid is optionally washed with an aqueous solution of an organic complex ligand (for example by resuspension and subsequent reisolation by filtration or centrifugation),
(D) wherein the solid obtained is subsequently dried, optionally after pulverization, at temperatures of generally 20-120° C. and at pressures of generally 0.1 mbar to standard pressure (1013 mbar),

and wherein, in the first step or immediately after the precipitation of the double metal cyanide compound (step (B)), one or more organic complex ligands, preferably in excess (based on the double metal cyanide compound), and optionally further complex-forming components are added.

The double metal cyanide compounds present in the DMC catalysts are the reaction products of water-soluble metal salts and water-soluble metal cyanide salts.

For example, an aqueous solution of zinc chloride (preferably in excess based on the metal cyanide salt, for example potassium hexacyanocobaltate) and potassium hexacyanocobaltate are mixed and then dimethoxyethane (glyme) or tert-butanol (preferably in excess based on zinc hexacyanocobaltate) is added to the suspension formed.

Metal salts suitable for preparation of the double metal cyanide compounds preferably have the general formula (II)

where

M is selected from the metal cations Zn²⁺, Fe²⁺, Ni²⁺, Mn²⁺, Co²⁺, Sr²⁺, Sn²⁺, Pb²⁺ and Cu²⁺; M is preferably Zn²⁺, Fe²⁺, Co²⁺ or Ni²⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

n is 1 when X=sulfate, carbonate or oxalate and

n is 2 when X=halide, hydroxide, carboxylate, cyanate, thiocyanate, isocyanate, isothiocyanate or nitrate,

or suitable metal salts have the general formula (III)

Mᵣ(X)₃ (III)

where

M is selected from the metal cations Fe³⁺, Al³⁺, Co³⁺ and Cr³⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

r is 2 when X=sulfate, carbonate or oxalate and

r is 1 when X=halide, hydroxide, carboxylate, cyanate, thiocyanate, isocyanate, isothiocyanate or nitrate,

or suitable metal salts have the general formula (IV)

M(X)_{S} (IV)

where

M is selected from the metal cations Mo⁴⁺, V⁴⁺ and W⁴⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

s is 2 when X=sulfate, carbonate or oxalate and

s is 4 when X=halide, hydroxide, carboxylate, cyanate, thiocyanate, isocyanate, isothiocyanate or nitrate,

or suitable metal salts have the general formula (V)

M(X)ₜ (V)

where

M is selected from the metal cations Mo⁶⁺ and W⁶⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

t is 3 when X=sulfate, carbonate or oxalate and

t is 6 when X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparation of the double metal cyanide compounds preferably have the general formula (VI)

(Y)ₐM′(CN)_{b}(A)_{c} (VI)

where

M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),

Y is selected from one or more metal cations from the group consisting of alkali metal (i.e. Li⁺, Na⁺, K⁺, Rb⁺) and alkaline earth metal (i.e. Be²⁺, Mg²⁺, Ca²⁺, Sr²⁺, Ba²⁺),

A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate, and

a, b and c are integers, the values for a, b and c being selected such as to ensure the electronic neutrality of the metal cyanide salt; a is preferably 1, 2, 3 or 4; b is preferably 4, 5 or 6; c preferably has the value 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds present in the DMC catalysts are compounds of the general formula (VII)

Mₓ[M′ₓ,(CN)_{y}]_{z} (VII)

where M is as defined in formula (II) to (V) and

M′ is as defined in formula (VI), and

x, x′, y and z are integers and are selected so as to ensure the electronic neutrality of the double metal cyanide compound.

Preferably,

x=3, x′=1, y=6 and z=2,

M=Zn(II), Fe(II), Co(II) or Ni(II) and

M′=Co(III), Fe(III), Cr(III) or Ir(III).

Examples of suitable double metal cyanide compounds are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in U.S. Pat. No. 5,158,922 (column 8, lines 29-66). Particular preference is given to using zinc hexacyanocobaltate(III).

The organic complex ligands added in the preparation of the DMC catalysts are disclosed, for example, in U.S. Pat. No. 5,158,922 (see especially column 6, lines 9 to 65), U.S. Pat. Nos. 3,404,109, 3,829,505, US-A 3 941 849, EP-A 700 949, EP-A 761 708, JP 4 145 123, U.S. Pat. No. 5,470,813, EP-A 743 093 and WO-A 97/40086). The organic complex ligands used are, for example, water-soluble organic compounds containing heteroatoms such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), compounds containing both aliphatic or cycloaliphatic ether groups and aliphatic hydroxyl groups (for example ethylene glycol mono-tert-butyl ether, diethylene glycol mono-tert-butyl ether, tripropylene glycol monomethyl ether and 3-methyl-3-oxetanemethanol). The most preferred organic complex ligands are selected from one or more compounds from the group consisting of dimethoxyethane, tert-butanol, 2-methyl-3-buten-2-ol, 2-methyl-3-butyn-2-ol, ethylene glycol mono-tert-butyl ether and 3-methyl-3-oxetanemethanol.

Optionally used in the preparation of the DMC catalysts are one or more complex-forming component(s) from the compound classes of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkylacrylates, polyalkylmethacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymers, hydroxyethyl cellulose and polyacetals, or of the glycidyl ethers, glycosides, carboxylic esters of polyhydric alcohols, gallic acid or the salts, esters or amides thereof, cyclodextrins, phosphorus compounds, α,β-unsaturated carboxylic esters or ionic surface- or interface-active compounds.

Preferably, in the preparation of the DMC catalysts, in the first step, the aqueous solutions of the metal salt (e.g. zinc chloride), used in a stoichiometric excess (at least 50 mol %) based on metal cyanide salt (i.e. at least a molar ratio of metal salt to metal cyanide salt of 2.25:1.00), and of the metal cyanide salt (e.g. potassium hexacyanocobaltate) are converted in the presence of the organic complex ligand (e.g. tert-butanol), forming a suspension containing the double metal cyanide compound (e.g. zinc hexacyanocobaltate), water, excess metal salt and the organic complex ligand.

The organic complex ligand may be present in the aqueous solution of the metal salt and/or of the metal cyanide salt or it is added directly to the suspension obtained after precipitation of the double metal cyanide compound. It has been found to be advantageous to mix the metal salt and the metal cyanide salt aqueous solutions and the organic complex ligand by stirring vigorously. Optionally, the suspension formed in the first step is subsequently treated with a further complex-forming component. This complex-forming component is preferably used in a mixture with water and organic complex ligand. A preferred process for performing the first step (i.e. the preparation of the suspension) is effected using a mixing nozzle, more preferably using a jet disperser as described in WO-A 01/39883.

In the second step (step (B)) the solid (i.e. the precursor of the catalyst) is isolated from the suspension by known techniques, such as centrifugation or filtration.

In a preferred variant, the isolated solid is subsequently washed in a third process step (step (C)) with an aqueous solution of the organic complex ligand (for example by resuspension and subsequent reisolation by filtration or centrifugation). Water-soluble by-products for example, such as potassium chloride, can be removed from the catalyst in this way. The amount of the organic complex ligand in the aqueous wash solution is preferably between 40% and 80% by weight, based on the overall solution. A further complex-forming component is optionally added to the aqueous wash solution in the third step, preferably in the range between 0.5% and 5% by weight, based on the overall solution.

It is also advantageous to wash the isolated solid more than once. It is preferable when in a first wash step (C-1) this solid is washed with an aqueous solution of the organic complex ligand (for example by resuspension and subsequent reisolation by filtration or centrifugation), in order in this way to remove, for example, water-soluble by-products, such as potassium chloride, from the catalyst. It is particularly preferable when the amount of the organic complex ligand in the aqueous wash solution is between 40% and 80% by weight based on the overall solution for the first wash step. In the further washing steps (C-2) either the first washing step is repeated once or several times, preferably from one to three times, or, preferably, a nonaqueous solution, such as a mixture or solution of organic complex ligand and further complex-forming component (preferably in the range between 0.5% and 5% by weight, based on the total amount of the wash solution of step (C-2)), is used as the wash solution, and the solid is washed with it once or more than once, preferably from one to three times.

The isolated and optionally washed solid is subsequently dried, optionally after pulverization, at temperatures of generally 20-100° C. and at pressures of generally 0.1 mbar to standard pressure (1013 mbar).

A preferred process for isolation of the DMC catalysts from the suspension by filtration, filtercake washing and drying is described in WO-A 01/80994.

As well as the DMC catalysts based on zinc hexacyanocobaltate (Zn₃[Co(CN)₆]₂) that are used with preference, it is also possible to use other metal complex catalysts based on the metals zinc and/or cobalt that are known to those skilled in the art from the prior art for the copolymerization of epoxides and carbon dioxide for the process according to the invention. This especially includes what are called zinc glutarate catalysts (described, for example, in M. H. Chisholm et al., Macromolecules 2002, 35, 6494), what are called zinc diiminate catalysts (described, for example, in S. D. Allen, J. Am. Chem. Soc. 2002, 124, 14284), what are called cobalt salen catalysts (described, for example, in U.S. Pat. No. 7,304,172 B2, US 2012/0165549 A1), and bimetallic zinc complexes having macrocyclic ligands (described, for example, in M. R. Kember et al., Angew. Chem., Int. Ed., 2009, 48, 931).

Preference is given to using a DMC catalyst for the process.

In a first embodiment, the invention relates to a process for continuously preparing polyethercarbonate polyols by addition of alkylene oxide and carbon dioxide in the presence of a DMC catalyst or a metal complex catalyst based on the metals cobalt and/or zinc onto H-functional starter substance, wherein
(α) a portion of the H-functional starter substance and/or a suspension medium having no H-functional groups is optionally initially charged in a reactor optionally together with DMC catalyst or a metal complex catalyst based on the metals and zinc and/or cobalt,
(β) a DMC catalyst is optionally activated by adding a portion (based on the total amount of alkylene oxide used in the activation and copolymerization) of the alkylene oxide to the mixture resulting from step (α), wherein this addition of a portion of alkylene oxide can optionally be carried out in the presence of CO₂ and wherein the temperature spike (“hotspot”) occurring on account of the subsequent exothermic chemical reaction and/or a pressure drop in the reactor is awaited in each case and wherein step (β) for activation may also be effected more than once,
(γ) H-functional starter substance, alkylene oxide and catalyst are metered continuously into the reactor during the addition, and the resulting reaction mixture is removed continuously from the reactor, characterized in that
(i) before step (γ) and after optional steps (α) and/or (β), a suspension of catalyst in suspension medium and/or H-functional starter substance in the reactor is adjusted to a temperature T₁ in the range from 100 to 150° C., where T₁ is at least 10%, based on T₂, above a temperature T₂ and T₂ is a temperature in the range from 50 to 135° C.,
(ii) from commencement of the addition of alkylene oxide in step (γ), the temperature T₁ established in (i) in the reactor is reduced continuously down to the temperature T₂, and the temperature T₂ is attained no earlier than after 50 minutes.

In a second embodiment, the invention relates to a process according to the first embodiment, characterized in that the temperature T₂ is 60 to 130° C.

In a third embodiment, the invention relates to a process according to the second embodiment, characterized in that the temperature T₁ is set within the range from 110 to 150° C.

In a fourth embodiment, the invention relates to a process according to any of embodiments 1 to 3, characterized in that the temperature T₁ is at least 15%, based on T₂, above the temperature T₂.

In a fifth embodiment, the invention relates to a process according to any of embodiments 1 to 3, characterized in that, in (ii), the temperature T₂ is attained no earlier than after 100 minutes.

In a sixth embodiment, the invention relates to a process according to any of embodiments 1 to 5, characterized in that the concentration of free alkylene oxide in the reactor during the addition of alkylene oxide is 1.5% to 5.0% by weight, based on the reaction mixture present in the reactor.

In a seventh embodiment, the invention relates to a process according to any of embodiments 1 to 6, characterized in that the alkylene oxide is selected from at least one compound from the group consisting of ethylene oxide and propylene oxide.

In an eighth embodiment, the invention relates to a process according to any of embodiments 1 to 7, characterized in that
(γ) one or more H-functional starter substance(s) containing at least 50 ppm of component K are metered continuously into the reactor during the reaction, component K being selected from at least one compound containing a phosphorus-oxygen bond or a compound of phosphorus that can form one or more P—O bond(s) by reaction with OH-functional compounds.

In a ninth embodiment, the invention relates to a process of any of embodiments 1 to 8, characterized in that the H-functional starter substance is selected from at least one compound of the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol, sorbitol, polyethercarbonate polyols having a molecular weight Mₙ in the range from 150 to 8000 g/mol with a functionality of 2 to 3, and polyether polyols having a molecular weight Mₙ in the range from 150 to 8000 g/mol with a functionality of 2 to 3.

In a tenth embodiment, the invention relates to a process according to any of embodiments 1 to 8, characterized in that the H-functional starter substance is selected from at least one compound of the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane and pentaerythritol.

In an eleventh embodiment, the invention relates to a process according to any of embodiments 1 to 10, characterized in that the continuous process is started up again after a shutdown time of 24 hours or less.

### EXAMPLES

The catalyst-starter mixture used in the examples consists of a suspension of 6.9 g of DMC catalyst (prepared according to example 6 of WO-A 01/80994) in 1000 g of a starter mixture of monopropylene glycol/glycerol, where the starter mixture contains 170 ppm of H₃PO₄ (85%).

### Example 1

A nitrogen-purged 60 L pressure reactor with gas metering device (gas inlet tube) and product discharge tube (reaction volume Vr 27.4 dm³), after production had been stopped, contained a product mixture of 30 litres and one CO₂ atmosphere. The reactor was heated up to 123° C. for restarting. The reactor containing CO₂ reached a pressure of 64 barg at that temperature. 500 g of propylene oxide (PO) was metered into the reactor at 123° C. (T₁) while stirring within 2 min. The start of the reaction was signaled by a temperature spike (“hotspot”) and a pressure drop and a change in the free PO concentration measured. This addition of propylene oxide was repeated for a second time. After activation twice, propylene oxide at 6.7 kg/h and the catalyst-starter mixture at 0.26 kg/h and 2.4 kg/h of CO₂ were metered simultaneously into the reactor (to). The reaction temperature was lowered to 106° C. (T₂) within 4 h, and the reaction mixture was withdrawn continuously from the reactor via the product discharge tube. The free PO concentration rose continuously from 0% by weight to 3.7% by weight of PO. No fluctuations in pressure and/or temperature were observed.

TABLE 1

| | Time | | | | | | |
|---|---|---|---|---|---|---|---|
| | Start of | | | | | | |
| | addition | | | | | | |
| | streams | Time t₀ + | Time t₀ + | Time t₀ + | Time t₀ + | Time t₀ + | Time t₀ + |
| | t₀ | 30 min | 60 min | 90 min | 120 min | 180 min | 240 min |
| Free PO | 0 | 1.4 | 2.2 | 2.8 | 2.9 | 3.5 | 3.7 |
| concentration | | | | | | | |
| [% by wt.] | | | | | | | |
| Temperature | 122 | 120 | 116 | 113 | 111 | 107 | 106 |
| [° C.] | | | | | | | |

### Example 2

A nitrogen-purged 60 L pressure reactor with gas metering device (gas inlet tube) and product discharge tube (reaction volume Vr 27.4 dm³), after production had been stopped, contained a product mixture of 40 litres and one CO₂ atmosphere. The reactor was kept at 107° C. during the stoppage. The reactor containing CO₂ remained at a pressure of 64 barg at that temperature. On restarting at 107° C., metered addition of propylene oxide at 7.2 kg/h and of the catalyst-starter mixture at 0.27 kg/h were established. It was not possible to run the reactor in a stable manner; there was significant fluctuation in the free PO concentration, combined with fluctuations in temperature and pressure. The mass flow rate of the metered addition of CO₂ was under pressure control, and therefore also fluctuated. These fluctuations are possible only with particular additional supervision of the experiment in experimental equipment, and are thus unsuitable for sustained operation on the production scale. The reaction would already have been shut down automatically for safety reasons on the production scale after the first amplitude in the process fluctuation.

TABLE 2

| | Time | | | | | | |
|---|---|---|---|---|---|---|---|
| | Start of | | | | | | |
| | addition | | | | | | |
| | streams | Time t₀ + | Time t₀ + | Time t₀ + | Time t₀ + | Time t₀ + | Time t₀ + |
| | t₀ | 23 min | 42 min | 73 min | 95 min | 150 min | 177 min |
| Free PO | 0.2 | 3.7 | 0.9 | 2.5 | 2.0 | 2.6 | 2.3 |
| concentration | | | | | | | |
| [% by wt.] | | | | | | | |
| Temperature | 107 | 104 | 119 | 109 | 111 | 107 | 108 |
| [° C.] | | | | | | | |

1. A process for continuously preparing polyethercarbonate polyols, the process comprising adding alkylene oxide and carbon dioxide in the presence of a DMC catalyst or a metal complex catalyst based on the metals cobalt and/or zinc onto H-functional starter substance, wherein
(α) a portion of the H-functional starter substance and/or a suspension medium having no H-functional groups is optionally initially charged in a reactor optionally together with DMC catalyst or a metal complex catalyst based on the metals and zinc and/or cobalt,
(β) a DMC catalyst is optionally activated by adding a portion of the alkylene oxide to the mixture resulting from step (α), wherein this addition of a portion of alkylene oxide can optionally be carried out in the presence of CO₂ and wherein the temperature spike occurring on account of the subsequent exothermic chemical reaction and/or a pressure drop in the reactor is awaited in each case and wherein step (β) for activation may also be effected more than once,
(γ) H-functional starter substance, alkylene oxide and catalyst are metered continuously into the reactor during the addition, and the resulting reaction mixture is removed continuously from the reactor,
wherein
(i) before step (γ) and after optional steps (α) and/or (β), a suspension of catalyst in suspension medium and/or H-functional starter substance in the reactor is adjusted to a temperature T₁ in the range from 100 to 150° C., wherein T₁ is at least 10%, based on T₂, above a temperature T₂ and wherein T₂ is a temperature in the range from 50 to 135° C., and
(ii) from commencement of the addition of alkylene oxide in step (γ), the temperature T₁ established in (i) in the reactor is reduced continuously down to the temperature T₂, and the temperature T₂ is attained no earlier than after 50 minutes.

2. The process as claimed in claim 1, wherein the temperature T₂ is 60 to 130° C.

3. The process as claimed in claim 2, wherein the temperature T₁ is set within the range from 110 to 150° C.

4. The process as claimed in claim 2, characterized in wherein the temperature T₁ is at least 15%, based on T₂, above the temperature T₂.

5. The process as claimed in claim 1, wherein, in (ii), the temperature T₂ is attained no earlier than after 100 minutes.

6. The process as claimed in claim 1, wherein the concentration of free alkylene oxide in the reactor during the addition of alkylene oxide is 1.5% to 5.0% by weight, based on the reaction mixture present in the reactor.

7. The process as claimed in claim 1, wherein the alkylene oxide comprises at least one compound selected from the group consisting of ethylene oxide and propylene oxide.

8. The process as claimed in claim 1, wherein
(γ) one or more H-functional starter substance(s) containing at least 50 ppm of component K are metered continuously into the reactor during the reaction, component K being selected from at least one compound containing a phosphorus-oxygen bond or a compound of phosphorus that can form one or more P—O bond(s) by reaction with OH-functional compounds.

9. The process as claimed in claim 1, wherein the H-functional starter substance comprises at least one compound selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol, sorbitol, polyethercarbonate polyols having a molecular weight Mₙ according to DIN 55672-1 in the range from 150 to 8000 g/mol with a functionality of 2 to 3, and polyether polyols having a molecular weight Mₙ according to DIN55672-1 in the range from 150 to 8000 g/mol and with a functionality of 2 to 3.

10. The process as claimed in claim 1, wherein the H-functional starter substance comprises at least one compound selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane and pentaerythritol.

11. The process as claimed in claim 1, wherein the continuous process is started up again after a shutdown time of 24 hours or less.
